(19) United States
(12) Patent Application Publication
(10) Pub. No.: US 2026/0117849 A1
(43) Pub. Date: Apr. 30, 2026

(54) Cable Joint Differential for Robot

(71) Applicant: Timeback Incorporated, Brooklyn, NY (US)

(72) Inventor: Mason Massie, Brooklyn, NY (US)

(21) Appl. No.: 19/077,590

(22) Filed: Mar. 12, 2025

Related U.S. Application Data
(60) Provisional application No. 63/644,845, filed on May 9, 2024.

(51) Int. Cl. F16H 37/12; B25J 9/10; B25J 17/02

(52) U.S. Cl. CPC F16H 37/122; B25J 9/104; B25J 17/0258

(57) ABSTRACT

Cable linkages are used to implement a 2-DoF joint. The output pulley of the joint can revolve around a first axis and can rotate around a second axis that is orthogonal to and offset from the first axis. The output pulley is mounted on an intermediate link, which rotates around the first axis. The output pulley is connected by cables to an idler pulley mounted on the intermediate link and to a pair of input pulleys which rotate around the first axis. When the input pulleys rotate in the same direction around the first axis, the intermediate link and the output pulley revolve around the first axis in that same direction. When the input pulleys rotate in different directions or by different amounts around the first axis, the output pulley rotates around the second axis, and also may revolve around the first axis.

### TECHNICAL FIELD

This application relates to robots and, more particularly, to mechanisms for jointed motion of robot limbs.

### BACKGROUND

Both humanoid and industrial robots are becoming ubiquitous. From puck-shaped vacuum cleaners to somersaulting combat droids, the technology has rapidly evolved. Many robots have jointed limbs with limited degrees of freedom (“DoF”). A joint in a robot limb may be driven by various mechanisms. One approach is to emulate animal musculature with counter-contracting cables or fibers.

Presently, there exist a number of joint designs for humanoid and industrial robots, such as serial actuators, bevel gear differentials, intersecting axis cable differentials, or differentials where connecting rods run directly from the actuator output on the more proximal link directly to the distal link.

### SUMMARY

The technology disclosed by this application makes use of cables and pulleys to implement a 2-DoF joint. The output link of the joint can revolve around a first axis and can rotate around a second axis that is orthogonal to and offset from the first axis. The output link is driven by an output pulley that is mounted on an intermediate link, which rotates around the first axis. The output pulley is connected by cables to a pair of input pulleys, which also rotate around the first axis. When the input pulleys rotate in the same direction around the first axis, the intermediate link and the output pulley revolve around the first axis in that same direction. When the input pulleys rotate in different directions or by different amounts around the first axis, the output pulley rotates around the second axis and also may revolve around the first axis.

### BRIEF DESCRIPTION OF THE DRAWINGS

FIG. 1A depicts an “exploded” view of an example of a two-degree-of-freedom (“2-DoF”) joint, which includes an intermediate link, output and idler pulleys, two input pulleys, cables that connect the pulleys, and motors for driving the input pulleys, according to an aspect of the disclosure.

FIG. 1B depicts a fully assembled view of the 2-DoF joint that is shown in FIG. 1A, in a neutral position.

FIG. 2 depicts the 2-DoF joint that is shown in FIG. 1B, with the output pulley rotated to a −150 degree position on the second axis.

FIG. 3A depicts the 2-DoF joint that is shown in FIG. 1B, with the output pulley rotated to a +150 degree position on the second axis.

FIG. 3B depicts the 2-DoF joint that is shown in FIG. 3A, with the output pulley rotated to a −90 degree position on the first axis

FIG. 4 depicts the 2-DoF joint that is shown in FIG. 1B, with the output pulley revolved to a −90 degree position on the first axis.

FIG. 5 depicts the 2-DoF joint that is shown in FIG. 1B, with the output pulley revolved to a +90 degree position on the first axis.

FIG. 6 depicts the 2-DoF joint that is shown in FIG. 1B, with the output pulley revolved to a +/−180 degree position on the first axis.

FIG. 7A depicts an “exploded” view of an example of a two-degree-of-freedom (“2-DoF”) joint, which includes an output link, output and idler pulleys, two input pulleys, cables that connect the pulleys, and motors and cranks for driving the input pulleys, according to an aspect of the disclosure.

FIG. 7B depicts a fully assembled view of the 2-DoF joint that is shown in FIG. 7A, with the output pulley in a neutral position on the second axis.

FIG. 8A depicts an “exploded” view of a two-degree-of-freedom (“2-DoF”) joint, which includes an output link, output and idler pulleys, two input pulleys, cables that connect the pulleys, and motors and belts for driving the input pulleys, according to an aspect of the disclosure.

FIG. 8B depicts a fully assembled view of the 2-DoF joint that is shown in FIG. 8A, with the output pulley in a neutral position on the second axis.

FIG. 9A depicts an “exploded” view of an example of a two-degree-of-freedom (“2-DoF”) joint, which includes an intermediate link, output and idler pulleys, two input pulleys, a pair of cables that connect the pulleys which are terminated on the input pulleys and pinned to the output pulley, and motors for driving the input pulleys, according to an aspect of the disclosure.

FIG. 9B depicts a fully assembled view of the 2-DoF join that is shown in FIG. 9A, with the output pulley in a neutral position on the second axis.

FIG. 9C depicts an “exploded” view of an example of a two-degree-of-freedom (“2-DoF”) joint, which includes an intermediate link, output and idler pulleys, two input pulleys, a pair of cables that connect the pulleys which are terminated on the output and idler pulleys and pinned to the input pulleys, and motors for driving the input pulleys, according to an aspect of the disclosure.

FIG. 9D depicts a fully assembled view of the 2-DoF join that is shown in FIG. 9C, with the output pulley in a neutral position on the second axis.

FIG. 10A depicts an “exploded” view of an example of a two-degree-of-freedom (“2-DoF”) joint, which includes an intermediate link, output and idler pulleys, two input pulleys, a single cable that connects the pulleys which is pinned to each of the pulleys, and motors for driving the input pulleys, according to an aspect of the disclosure.

FIG. 10B depicts a fully assembled view of the 2-DoF join that is shown in FIG. 10A with the output pulley in a neutral position on the second axis.

FIG. 11 depicts an assembled tensioning mechanism including a worm gear that independently rotates halves of a split pulley.

### DETAILED DESCRIPTION

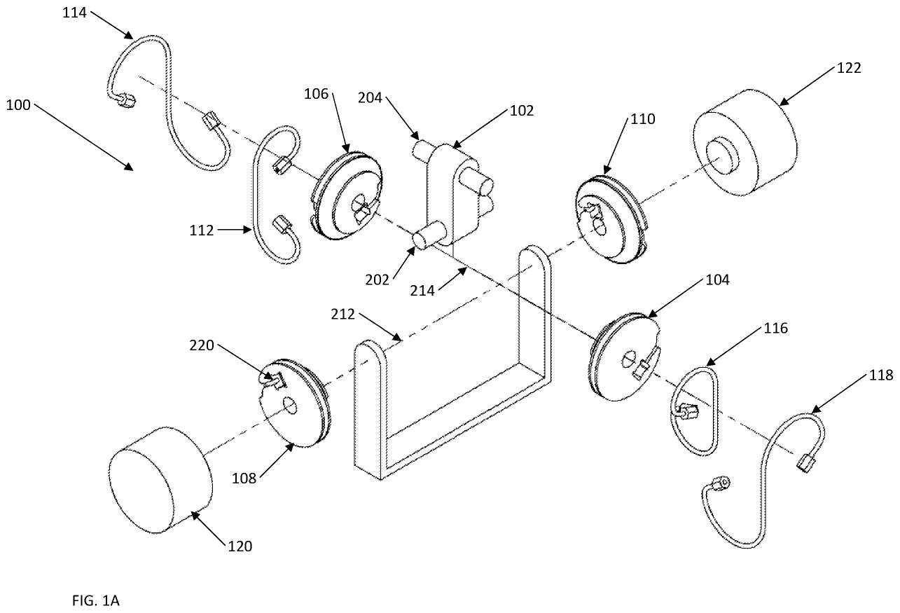

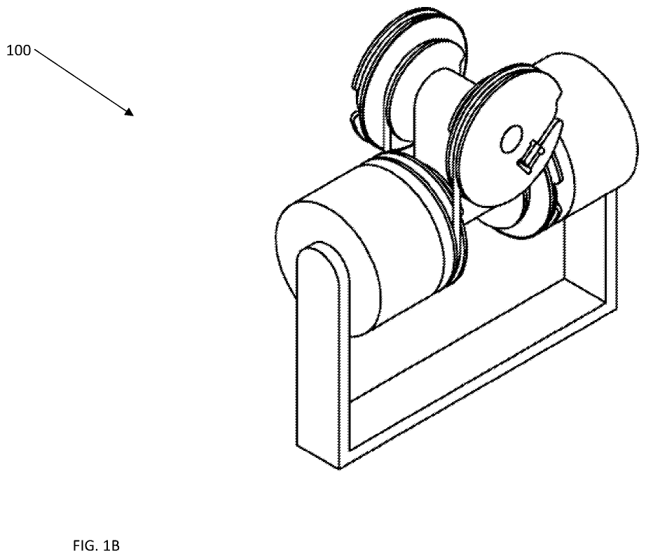

FIG. 1A depicts an “exploded” view of an example of a two-degree-of-freedom (“2-DoF”) joint 100. FIG. 1B depicts a fully assembled view of the 2-DoF joint 100. The joint 100 includes an intermediate link 102, output and idler pulleys 104 and 106, two input pulleys 108 and 110, cables 112, 114, 116, and 118 that connect the pulleys, and motors 120 and 122 for driving the input pulleys, according to an aspect of the disclosure. The input pulleys 108, 110 and the intermediate link 102 are independently rotatable around a first axis 212. The output and idler pulleys 104, 106 are independently rotatable around a second axis 214. The second axis 214, which is defined by the intermediate link 102, can revolve around the first axis 212.

In FIG. 1B, the 2-DoF joint 100 is shown with the output pulley 104 in a neutral position. As further discussed herein, rotation of the input pulleys 108, 110 by the motors 120, 122 can move the output pulley 104 and the intermediate link 102 to different positions with respect to the first and second axes 212, 214.

The cables 112, 114, 116, 118 are wrapped around each set of pulleys with about 180 degrees of wrap on each pulley. Wrapping more or less cable around each pulley will reduce range of motion of the joint. Wrapping more cable will mean that each cable tries to occupy the same groove before the output pulley has rotated 180 degrees around the second axis. Wrapping less cable means that the cables no longer will be tangent to the pulley grooves before the output pulley has rotated 180 degrees around the second axis. The total number of degrees over wrapped or under wrapped, divided by 4, is equal to the reduction in degrees of range of motion of the output pulley around the second axis, assuming all pulleys are identical in wrap.

Rotation of the output pulley about the first axis in response to rotation of the input pulleys, where the input pulleys have the same diameter, is described by the following equation: ((Input Angle 1)+(Input Angle 2))/2=(Output Angle Axis 1)

Rotation of the output pulley about the second axis in response to rotation of the input pulleys, where the input pulleys have the same diameter, is described by the following equation: (((Input Angle 1)−(Input Angle 2))/2)*(Input Pulley Radius)/(Output Pulley Radius)=(Output Angle Axis 2)

The intermediate link 102 includes a first axle 202 and also includes a second axle 204 that is disposed orthogonal to the first axle. When the 2-DoF joint 100 is fully assembled, the first axle 202 is rotatably connected between the input pulleys 108, 110 along the first axis 212 and the second axle 204 is rotatably connected between the output pulley 104 and the idler pulley 106 along the second axis 214. The first and second axles are freely rotatable within the pulleys.

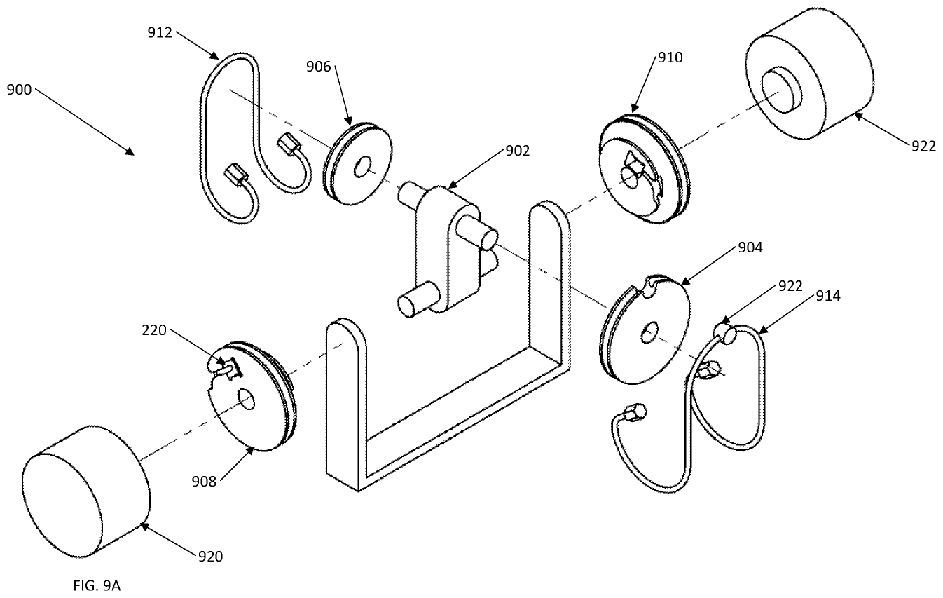

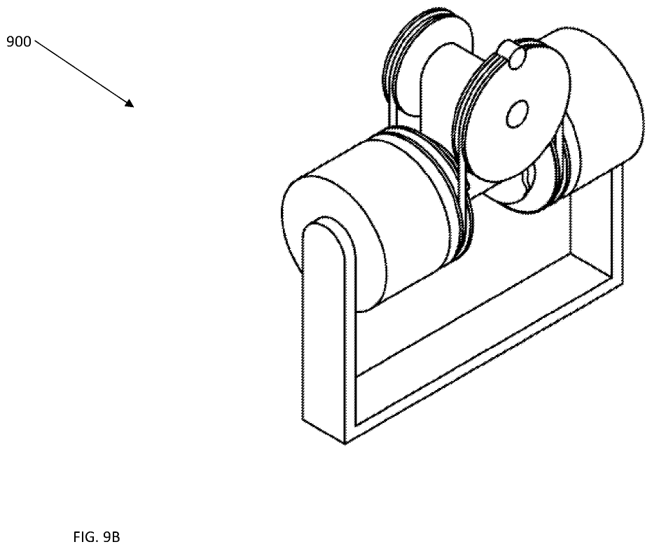

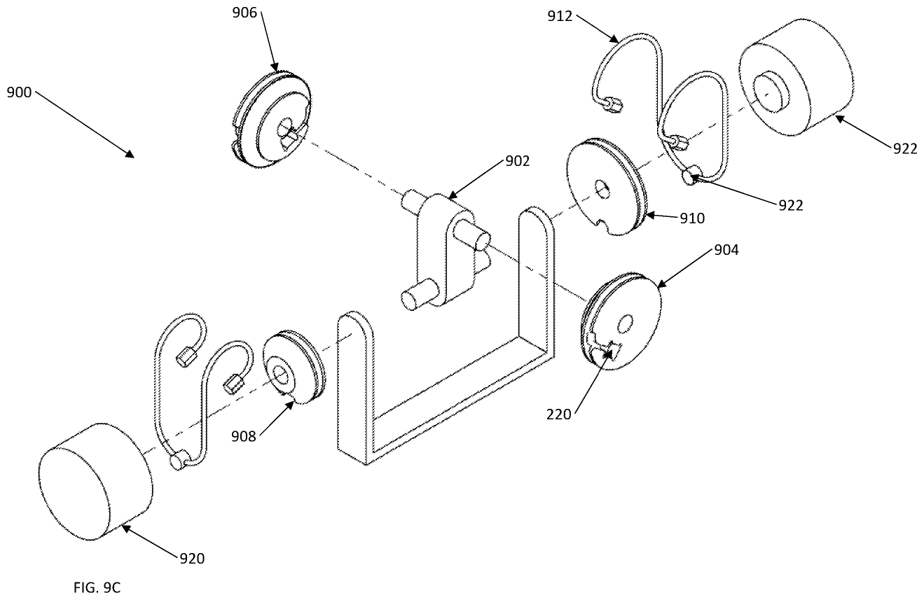

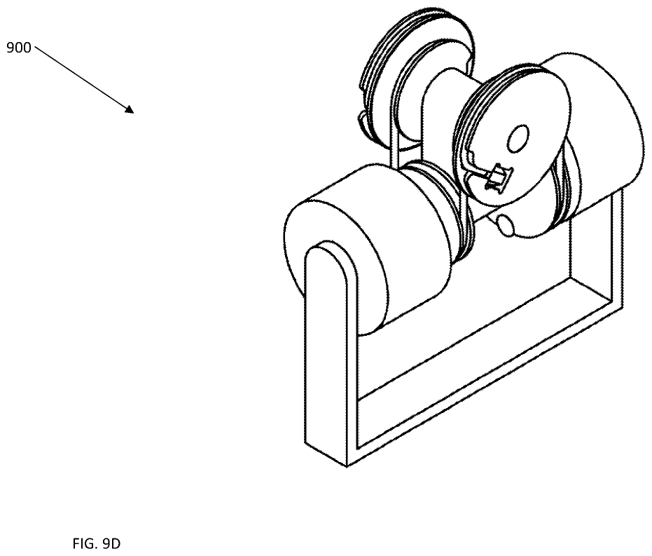

Each end of each cable 112, 114, 116, or 118 includes a block-and-screw arrangement 220 in which a threaded block is fastened to an end of the cable (e.g., by crimping) and is threaded into a screw, which is fastened to one of the pulleys. Rotating the screw in the block can adjust the tension on the cable. Other tensioning mechanisms could include a worm gear (as shown in FIG. 9) that independently rotates halves of split pulleys, a clamping hub, a threaded termination, lengthening the intermediate link, etc.

There could be one or more tensioning mechanisms on any one or more of the four pulleys. For example, one half of a pulley could have a clamping hub that gripped the other half. This clamping hub could be tightened after manually clocking the two halves against one another. As another example, the tensioning mechanism could also be an extension of the intermediate link length increasing the distance between the two axes.

The axles 202, 204 are freely rotatable with respect to the pulleys. Therefore, motion of the intermediate link around the first axis, and motion of the output pulley and the idler pulley around the second axis, are driven only by interactions of the cables with the pulleys. The output pulley 104 can move up to +/−180 degrees around the second axis 214 before the cables are no longer tangent to the pulley grooves.

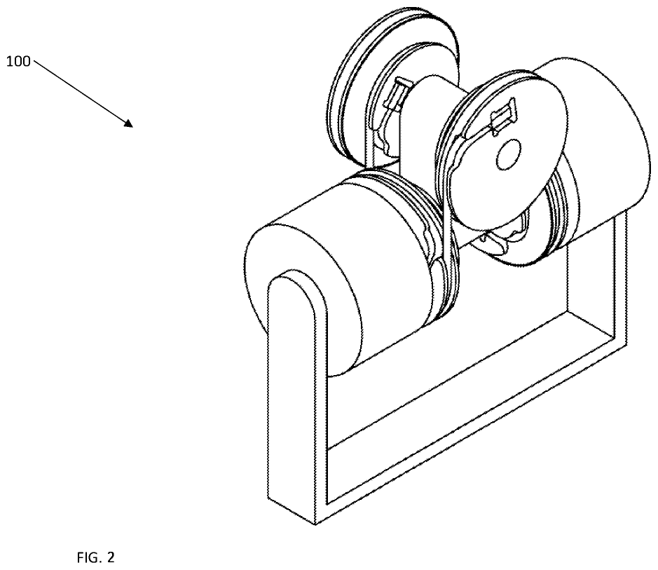

For example, rotating the top edge of the input pulley 108 toward the viewer and rotating the top edge of the input pulley 110 away from the viewer in FIG. 1B causes the output pulley 104 to rotate to a −150 degree position around the second axis, as depicted in FIG. 2.

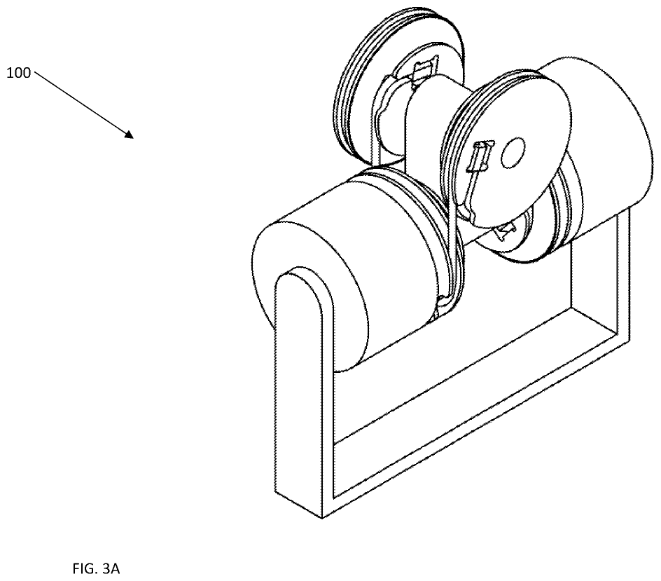

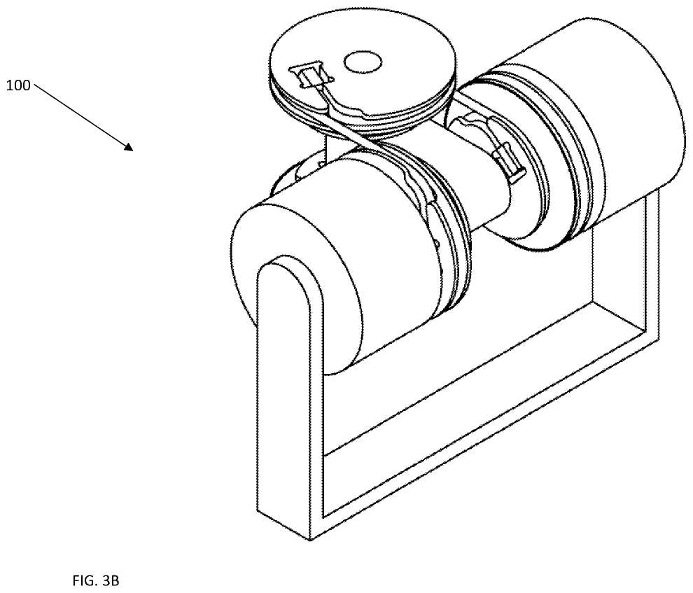

As another example of the kinematics of the 2-DoF joint 100, if the top edge of the nearer input pulley 108 is rotated away from the viewer in FIG. 1B while the top edge of the further input pulley 110 is rotated toward the viewer, then the output pulley 104 rotates to a +150 degree position around the second axis, as depicted in FIG. 3A.

As another example of the kinematics of the 2-DoF joint 100, if the top edges of the nearer input pulley 108 and the farther input pulley 110 are rotated away from the viewer in FIG. 3A, then the output pulley 104 revolves to a −90 degree position around the first axis, as depicted in FIG. 3B. Alternatively, such motion may also be accomplished by rotating the top edges of the nearer input pulley 108 and of the farther input pulley 110 away from the viewer in unequal amounts, with the farther input pulley 110 being rotated a larger number of degrees or at a faster rate than the nearer input pulley 108. In this example of the kinematics, the 2-DoF joint 100 is able to simultaneously articulate about both the first axis and the second axis. The 2-DoF joint 100 depicted in any of FIGS. 1A-10B may move in this type of combination or simultaneous motion.

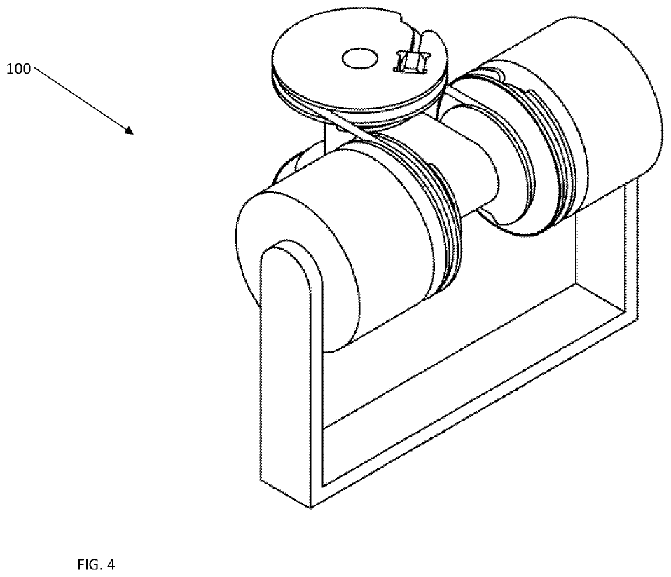

As another example of the kinematics of the 2-DoF joint 100, if the top edges of the nearer input pulley 108 and the farther input pulley 110 are rotated away from the viewer in FIG. 3, then the intermediate link 102 rotates and the output pulley 104 revolves to a −90 degree position around the first axis, as depicted in FIG. 4.

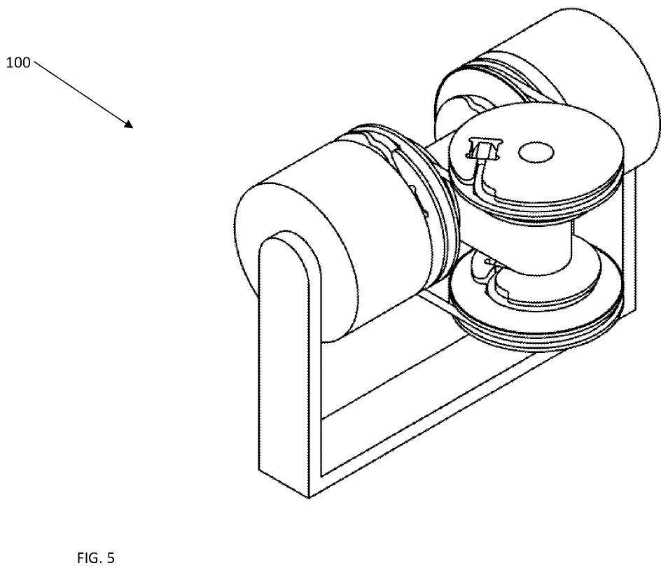

As another example of the kinematics of the 2-DoF joint 100, if the top edges of the nearer input pulley 108 and of the farther input pulley 110 are rotated toward the viewer of FIG. 4, then the intermediate link 102 rotates and the output pulley 104 revolves to a +90 degree position around the first axis, as depicted in FIG. 5.

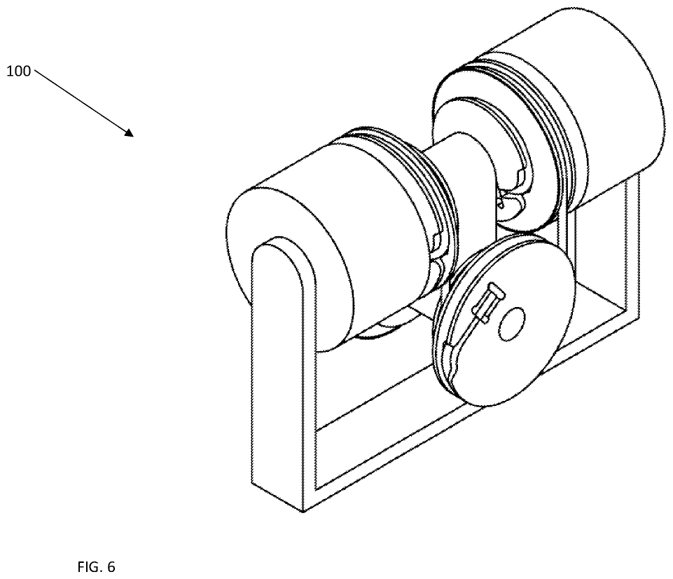

As another example of the kinematics of the 2-DoF joint 100, if the top edges of the nearer input pulley 108 and of the farther input pulley 110 are rotated toward the viewer of FIG. 5, then the intermediate link 102 rotates and the output pulley 104 revolves to a +/−180 degree position around the first axis, as depicted in FIG. 6.

As mentioned, the motors 120, 122 are connected to drive the input pulleys 108, 110. In some embodiments of the technology, the motors may be brushless permanent magnet motors that are controlled in closed loop mode by motor drivers in response to signals from optical, magnetic, hall effect, or capacitive/resistive/inductive position encoders. In other embodiments, the motors may be hydraulic motors that are controlled in closed loop mode by operation of solenoid valves in response to signals from Hall effect position encoders, or the motors may be other types of electric motors including induction motors, reluctance motors, stepper motors, or servo motors. In yet other embodiments, the motors may be controlled in closed loop or open loop by an autoencoder that outputs motor driver signals based on periodically processing weights of a computer vision neural network. The skilled worker will be aware of many possible combinations of alternative motor configurations and control modes in light of the present disclosure.

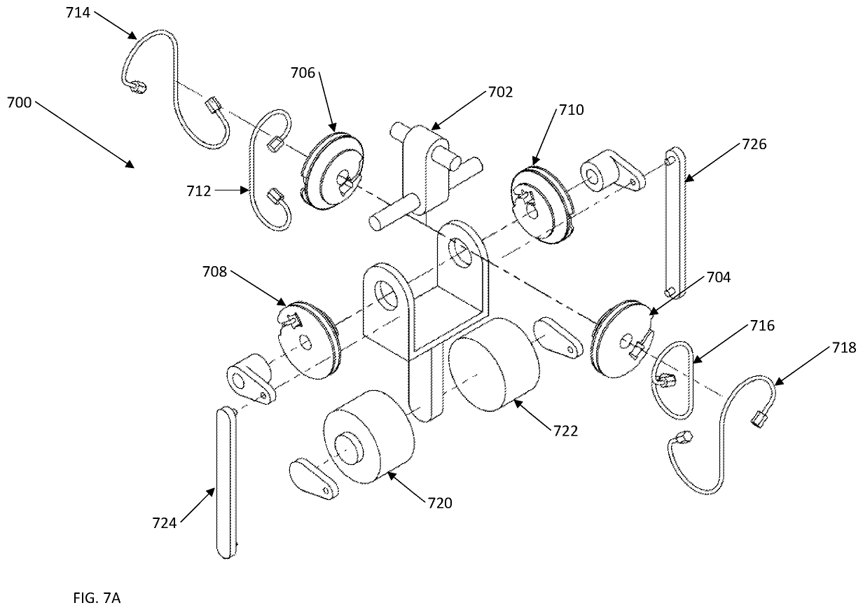

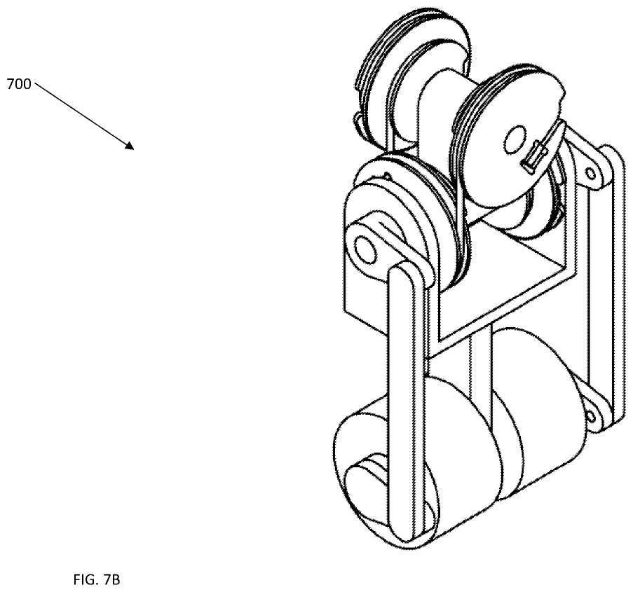

FIG. 7A depicts an “exploded” view of an example of a two-degree-of-freedom (“2-DoF”) joint 700, which includes an intermediate link 702, output and idler pulleys 704 and 706, two input pulleys 708 and 710, cables 712, 714, 716, 718 that connect the pulleys, and motors 720, 722 and cranks 724, 726 for driving the input pulleys, according to an aspect of the disclosure. FIG. 7B depicts a fully assembled view of FIG. 7A.

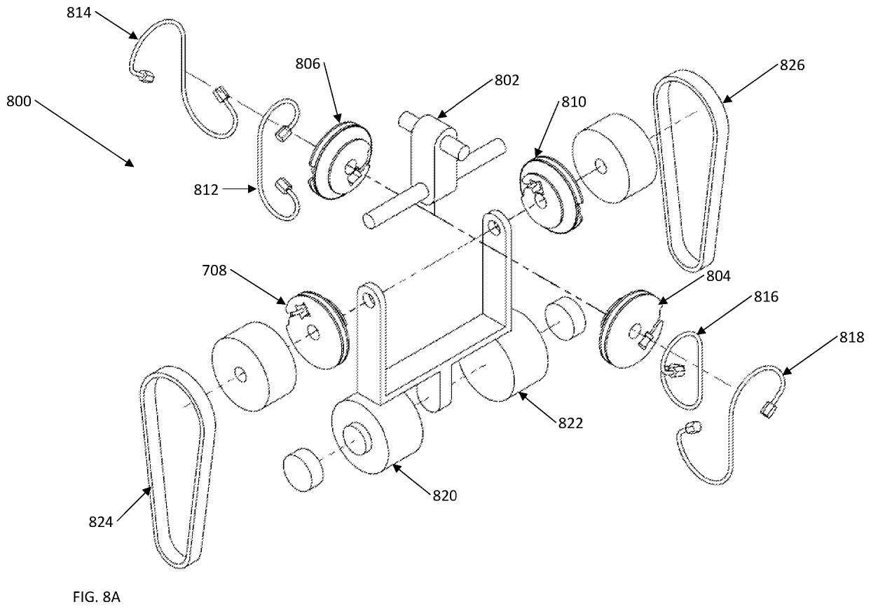

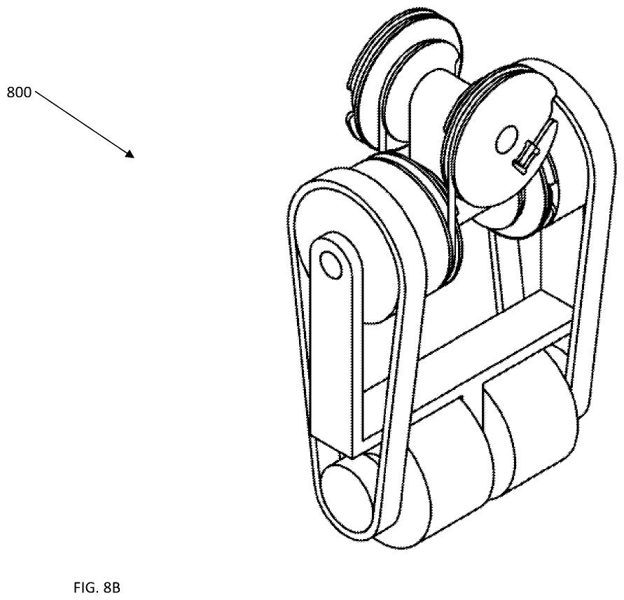

FIG. 8A depicts an “exploded” view of an example of a two-degree-of-freedom (“2-DoF”) joint 800, which includes an intermediate link 802, output and idler pulleys 804 and 806, two input pulleys 808 and 810, cables 812, 814, 816, 818 that connect the pulleys, and motors 820, 822 and belts 824, 826 for driving the input pulleys, according to an aspect of the disclosure. FIG. 8B depicts a fully assembled view of FIG. 8A.

FIG. 9A depicts an “exploded” view of an example of a two-degree-of-freedom (“2-DoF”) joint 900, which includes an intermediate link 902, output and idler pulleys 904 and 906 of different diameters with the idler pulley being smaller in diameter than the output pulley, two input pulleys 908 and 910, cables 812, 814 that connect the pulleys, and motors 920, 922 for driving the input pulleys, according to an aspect of the disclosure. FIG. 9B depicts a fully assembled view of FIG. 9A.

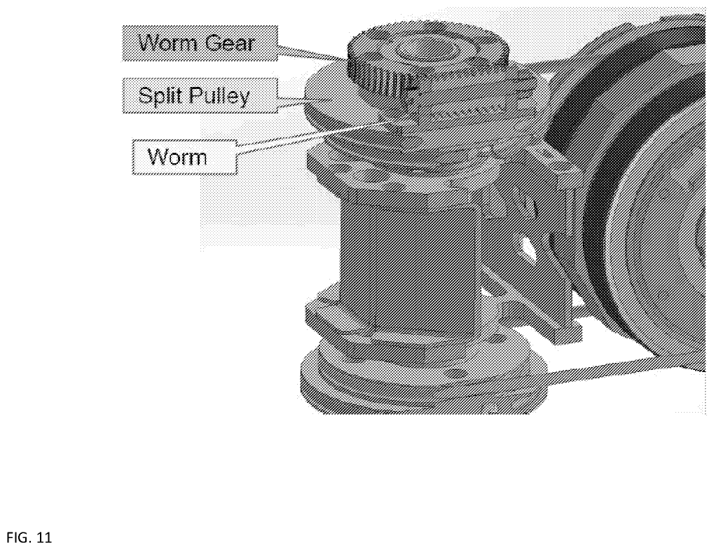

Each end of each cable 912 or 914 includes a block-and-screw arrangement 220 in which a threaded block is fastened to an end of the cable (e.g., by crimping) and is threaded into a screw, which is fastened to one of the pulleys. Rotating the screw in the block can adjust the tension on the cable. Other tensioning mechanisms could include a worm gear (as shown in FIG. 11) that independently rotates halves of split pulleys, a clamping hub, a threaded termination, lengthening the intermediate link, etc. Cable 914 includes a pin 922 which mates with a recess in output pulley 904. In other embodiments, cable 912 may also include a pin which mates with a recess in idler pulley 906 (which may further be the same diameter as output pulley 904).

FIG. 9C depicts an “exploded” view of an example of a two-degree-of-freedom (“2-DoF”) joint 900, which includes an intermediate link 902, output and idler pulleys 904 and 906, two input pulleys 908 and 910 with one being smaller in diameter than the other, cables 912, 914 that connect the pulleys, and motors 920, 922 for driving the input pulleys, according to an aspect of the disclosure. FIG. 9D depicts a fully assembled view of FIG. 9C.

Each end of each cable 912 or 914 includes a block-and-screw arrangement 220 in which a threaded block is fastened to an end of the cable (e.g., by crimping) and is threaded into a screw, which is fastened to one of the pulleys. Rotating the screw in the block can adjust the tension on the cable. Other tensioning mechanisms could include a worm gear (as shown in FIG. 11) that independently rotates halves of split pulleys, a clamping hub, a threaded termination, lengthening the intermediate link, etc. Cables 912, 914 include a pin 922 which mates with a recess in input pulleys 908, 910. In other embodiments, one of cable 912 or 914 may not include a pin which mates with a recess in an input pulley 908 or 910 (which may further be the same diameter as each other).

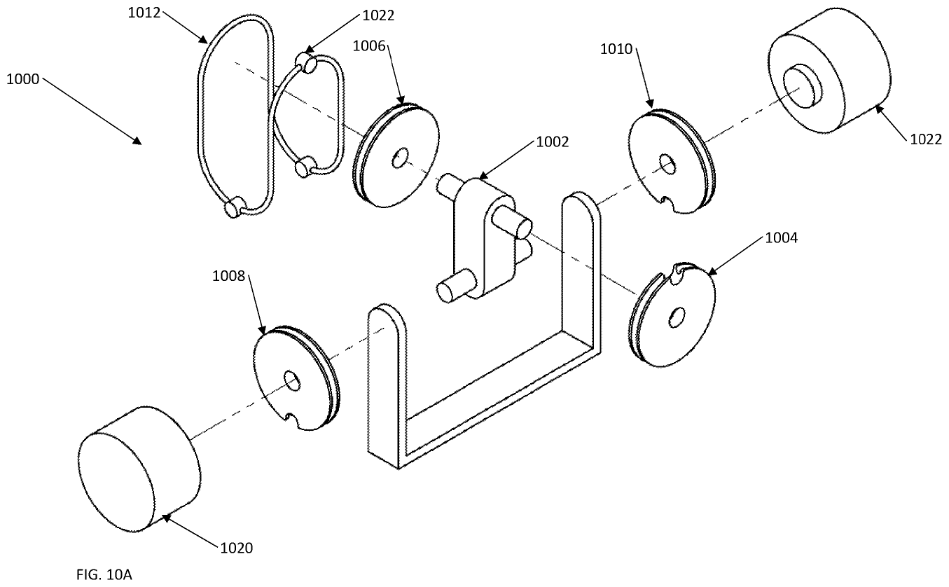

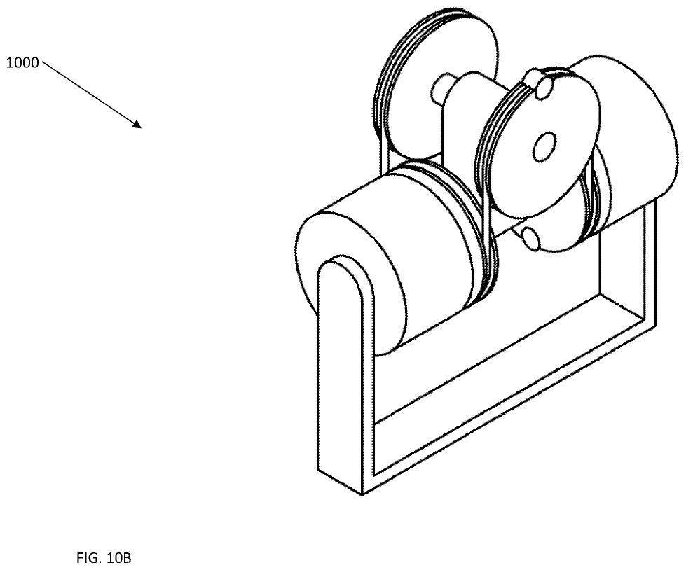

FIG. 10A depicts an “exploded” view of an example of a two-degree-of-freedom (“2-DoF”) joint 1000, which includes an intermediate link 1002, output and idler pulleys 1004 and 1006, two input pulleys 1008 and 1010, a single cable 1012 that connects the pulleys, and motors 1020, 1022 for driving the input pulleys, according to an aspect of the disclosure. FIG. 10B depicts a fully assembled view of FIG. 10A.

No end of the cable 1012 includes a block-and-screw arrangement. Tensioning mechanisms could include lengthening the intermediate link, etc. Cable 1012 includes three pins 1022 which mate with a recess in input pulleys 1008, 1010 and output pulley 1004. In other embodiments, cable 1012 may include four pins or other means of attaching to at least three pulleys.

FIG. 11 depicts an assembled tensioning mechanism including a worm gear that independently rotates halves of a split pulley.

What is claimed is:

1. A motor-drivable two degrees of freedom joint comprising:
a first input pulley that rotates around a first axis;
a second input pulley that rotates around the first axis and is spaced apart from the first input pulley along the first axis, wherein the second input pulley can rotate independent from the first input pulley;
an intermediate link that rotates around the first axis, wherein the intermediate link defines a second axis that is orthogonal to and offset from the first axis;
an output pulley that is mounted to rotate around the second axis of the intermediate link;
an idler pulley that is mounted to rotate around the second axis of the intermediate link, wherein the idler pulley is spaced apart from the output pulley along the second axis; and
one or more cables connecting the input pulleys, output pulley, and idler pulley, such that the rotation of the input pulleys in the same or different directions results in the output pulley rotating around the first and/or second axis.

2. The joint of claim 1, wherein the cables comprise:
a first driving cable that at one end is coupled to the first input pulley and that at the other end is coupled to the output pulley; and
a second driving cable that at one end is coupled to the output pulley and that at the other end is coupled to the second input pulley; and
a third driving cable that at one end is coupled to the second input pulley and that at the other end is coupled to the idler pulley; and
a fourth driving cable that at one end is coupled to the idler pulley and that at the other end is coupled to the first input pulley.

3. The joint of claim 1, wherein the intermediate link is disposed between the first input pulley and the second input pulley along the first axis.

4. The joint of claim 1, wherein the total angular contact of the sum of the first driving cable and second driving cable and first idler cable and second idler cable about the first input pulley and second input pulley and output pulley and idler pulley is equal to 1440 degrees.

5. The joint of claim 1, further comprising a first motor connected to drive the first input pulley.

6. The joint of claim 5, wherein the second input pulley is selectively disconnected from the first input pulley.

7. The joint of claim 1, wherein one of the first input pulley or the second input pulley or the idler pulley or the output pulley is further comprised of two halves independently rotatable about the first axis, the first half mounting one of the driving cables and the second half mounting one of the idler cables, said first half having a worm gear mounted to its face enmeshed with a tensioning gear mounted to the second half, wherein rotation of the worm gear against the tensioning gear rotates the first half against the second half.

8. The joint of claim 1, further comprising a first motor connected to drive the first input pulley, and a second motor connected to drive the second input pulley.

9. The joint of claim 8, further comprising a motor controller processor that is configured by computer-executable instructions to coordinate the operation of the first and second motors to achieve desired movements of the output pulley around both the first and second axes.

10. The joint of claim 9, wherein the motor controller processor is configured to implement a method comprising:
receiving a target sequence of rotary movements for the output link;
translating the target sequence of rotary movements to a sequence of motor commands for the first and second motors; and
driving the first and second motors according to the sequence of motor commands.

11. The joint of claim 8, further comprising first and second rotary encoders, which are associated with the respective first and second motors for closed-loop control of the motors.

12. The joint of claim 1, wherein the rotation of the output pulley around the first axis is determined by the average rotational input of the first and second input pulleys, and the rotation of the output pulley around the second axis is determined by the differential rotational input of the first and second input pulleys.

13. A method for moving a joint in two degrees of freedom, the method comprising, in any order:
rotating a first input pulley around a first axis while rotating a second input pulley around the first axis in the same direction and in the same amount as the first input pulley, thereby causing an output pulley and idler pulley to rotate around the first axis; and
rotating one of the first input pulley or the second input pulley around the first axis while rotating the other input pulley in an opposite direction in the same amount, thereby causing the output pulley and the idler pulley to rotate around a second axis that is orthogonal to and offset from the first axis; and
rotating one of the first input pulley or the second input pulley around the first axis while rotating the other input pulley in a different amount, thereby causing the output pulley and the idler pulley to rotate around both the first axis and the second axis.

14. The method of claim 13, wherein when the first input pulley and the second input pulley are aligned to each other, the output pulley is in a neutral position with respect to the second axis, wherein at the extreme position of the first input pulley, the output pulley is rotated 180 degrees from the neutral position around the second axis.

15. A motor-drivable two degrees of freedom joint comprising:
a first input pulley that rotates around a first axis;
a second input pulley that rotates around the first axis, wherein the second input pulley is spaced apart from the first input pulley along the first axis, wherein the second input pulley can rotate independent from the first input pulley;
an intermediate link that is disposed between the first and second input pulleys along the first axis, wherein the intermediate link rotates around the first axis, wherein the intermediate link defines a second axis that is orthogonal to and offset from the first axis;
an output pulley that rotates around the second axis of the intermediate link;
an idler pulley that rotates around the second axis of the intermediate link, wherein the idler pulley is spaced apart from the output pulley along the second axis;
a driving cable which, along its length and in this order or the reverse order, is in contact with the first input pulley, the output pulley, the second input pulley, and the idler pulley;
wherein the driving cable is coupled to a point on each pulley.

16. The joint of claim 15, wherein when the joint is in a neutral position, the distance along the driving cable between each coupled point on each pulley is equal.

17. The joint of claim 15, wherein the driving cable is divided into a first and second driving cable, the first driving cable terminated on the first input pulley and pinned on the output pulley and terminated on the second input pulley, and the second driving cable terminated on the second input pulley and pinned on the idler pulley and terminated on the first input pulley.

18. The joint of claim 15, wherein the driving cable is divided into a first and second driving cable, the first driving cable terminated on the output pulley and pinned on the first input pulley and terminated on the idler pulley, and the second driving cable terminated on the output pulley and pinned on the second input pulley and terminated on the idler pulley.
